(19) United States
(12) Patent Application Publication
(10) Pub. No.: US 2024/0323822 A1
(43) Pub. Date: Sep. 26, 2024

(54) BEACON SENDING AND RECEIVING METHODS AND APPARATUS

(71) Applicant: HUAWEI TECHNOLOGIES CO., LTD., Shenzhen (CN)

(72) Inventors: Tianhang Yu, Hangzhou (CN); Yunfei Qiao, Hangzhou (CN); Rong Li, Boulogne Billancourt (FR); Jun Wang, Hangzhou (CN)

(21) Appl. No.: 18/732,331

(22) Filed: Jun. 3, 2024

Related U.S. Application Data
(63) Continuation of application No. PCT/CN2022/130826, filed on Nov. 9, 2022.

(30) Foreign Application Priority Data
Dec. 2, 2021 (CN) 202111463385.1

(51) Int. Cl. H04W 48/16; H04L 5/00; H04W 48/10

(52) U.S. Cl. CPC H04W 48/16; H04L 5/0048; H04L 5/0098; H04W 48/10

(57) ABSTRACT

The present disclosure relates to the communication field and discloses beacon sending and receiving methods and corresponding apparatuses for reducing hardware overheads and weights of a network device such as a satellite or a high-altitude platform and a terminal device such as a ground station. A method is provided that includes determining one or more subcarriers that are in a first frequency band, the first frequency band being one of N frequency bands included in a first beacon resource of the first send node, N being an integer greater than or equal to 1. The first send node sends a beacon signal on the one or more subcarriers. Correspondingly, a first receive node receives the beacon signal on the one or more subcarriers. The first receive node parses the beacon signal.

### CROSS-REFERENCE TO RELATED APPLICATION

This application is a continuation of International Patent Application No. PCT/CN2022/130826, filed on Nov. 9, 2022, which claims priority to Chinese Patent Application No. 202111463385.1, filed on Dec. 2, 2021. The disclosures of the aforementioned applications are hereby incorporated by reference in their entireties.

### TECHNICAL FIELD

Embodiments of the present disclosure relate to the field of communication technologies, and in particular, to beacon sending and receiving methods and corresponding apparatuses.

### BACKGROUND

A non-terrestrial network (NTN) has advantages of wide coverage, a long communication distance, high reliability, high flexibility, high throughput, and being free from impact of a geographical environment, climate conditions, and natural disasters, and has been widely used in fields such as aeronautical communication, maritime communication, and military communication. The NTN is introduced into a mobile communication system, for example, into a 5th generation (5G) system, so that not only a communication service can be provided for an area that is difficult for a terrestrial network to cover, for example, an ocean, a forest, a desert, or a mountain, but also communication reliability can be enhanced. For example, a more stable and better communication service can be provided for a train, an airplane, and users on these vehicles, and more data transmission resources are provided, for example, more terminal device connections of a larger quantity are supported.

However, current measurement and control devices, communication devices, and the like carried on a satellite or a high-altitude platform in the NTN are independent of each other. The measurement and control device may be configured to send and receive a beacon signal between satellites or between a satellite and a ground station, and is used for antenna alignment, telemetry information transmission, remote control information transmission, or the like. The communication device may be configured to provide a data transmission service for a terminal device. The terminal device (for example, the ground station) also needs to use a beacon transceiver and a communication transceiver that are separated, to respectively process a beacon signal and a data transmission signal. Deployment of a plurality of sets of hardware devices such as the measurement and control device and the communication devices not only increases hardware costs of the satellite or the high-altitude platform and the terminal device, but also increases a weight of the satellite or the high-altitude platform. Therefore, how to implement integration of beacon communication and data transmission communication is a problem worth considering.

### SUMMARY

Embodiments of the present disclosure provide beacon sending and receiving methods and an apparatus, to reduce hardware overheads and weights of a network device such as a satellite or a high-altitude platform and a terminal device such as a ground station.

According to a first aspect, an embodiment provides a beacon receiving method. The method includes: A first receive node determines one or more subcarriers that are in a first frequency band, where the first frequency band is one of N frequency bands included in a first beacon resource of a first send node, and N is an integer greater than or equal to 1. The first receive node receives a beacon signal on the one or more subcarriers. The first receive node parses the beacon signal.

The communication method may be performed by the first receive node, or may be performed by a component (for example, a processor, a chip, or a chip system) of the first receive node, or may be implemented by a logical module or software that can implement all or some functions of the first receive node. The first receive node may be a network device such as a satellite or a high-altitude platform, or may be a terminal device, or may be a ground station.

The foregoing method is used, so that the beacon signal and data transmission communication may use a unified standard, for example, a new radio (NR) standard. A frequency band is configured for a beacon in a data transmission frequency band. A send node of the beacon signal may send the beacon signal on one or more subcarriers that are in the frequency band configured for the beacon, and a corresponding receive node receives the beacon signal on the one or more subcarriers that are in the frequency band, so that beacon communication and the data transmission communication may use a same set of transceiver devices. This reduces hardware overheads and weights of the send node of the beacon signal and the receive node of the beacon signal. For example, hardware overheads and weights of a network device such as a satellite or a high-altitude platform and a terminal device such as a ground station can be reduced.

In a possible design, the beacon signal includes at least one of the following: a preset level signal, a preset modulation symbol, a reference signal used for navigation and/or measurement and control, measurement and control information, or the like. Optionally, a quantity of subcarriers receiving the preset level signal or the preset modulation symbol is less than or equal to a preset threshold.

In the foregoing design, the beacon signal may be one or more of the following: the preset level signal, the preset modulation symbol, the reference signal used for navigation and/or measurement and control, the measurement and control information, or the like. Alternatively, a standard unified with that of the data transmission communication may be used for measurement and control signals, navigation signals, and the like. This reduces hardware overheads and weights of the send node of the beacon signal and the receive node of the beacon signal.

In a possible design, a non-cyclic prefix (CP) mode is used to receive the preset level signal or the preset modulation symbol.

In the foregoing design, a preset level signal or a preset modulation symbol that occupies a small quantity of subcarriers is sent and received in a CP-free mode. This ensures phase continuity of a signal on the subcarrier and reduces inter-carrier interference to a data signal on a data transmission frequency band.

In a possible design, the method further includes: The first receive node receives first signaling from the first send node, where the first signaling indicates to update the first beacon resource to a third beacon resource. The first receive node updates the first beacon resource of the first send node to the third beacon resource.

In the foregoing design, a beacon resource may be flexibly configured among a plurality of send nodes. Send nodes that do not cover a same receive node may reuse a same beacon resource. A plurality of send nodes that cover a same receive node may be updated through a beacon resource configuration, to avoid a collision of beacon resources.

In a possible design, before the first receive node receives the first signaling from the first send node, the method further includes: The first receive node determines that the first send node and a second send node cover the first receive node, and that the first beacon resource and a second beacon resource of the second send node overlap in frequency domain. The first receive node sends second signaling to the first send node, where the second signaling indicates that the beacon resources of the first send node and the second send node overlap in frequency domain.

In the foregoing design, the receive node may determine whether the send nodes cover the same receive node and whether the beacon resources collide. When the send nodes cover the same receive node and the beacon resources collide, the send node is requested to update the beacon resource configuration. This avoids a collision of the beacon resources among the send nodes covering the same receive node and improves communication reliability.

In a possible design, the method further includes: The first receive node determines that the first send node and a second send node cover the first receive node, and that the first beacon resource and a second beacon resource of the second send node overlap in frequency domain. The first receive node sends third signaling to the first send node, where the third signaling indicates to update the first beacon resource to a third beacon resource. Optionally, the method further includes: The first receive node updates the first beacon resource of the first send node to the third beacon resource.

In the foregoing design, when the receive node determines that the send nodes cover the same receive node and the beacon resources collide, the send node may be indicated on how to update the beacon resource configuration. This avoids a collision of the beacon resources among the send nodes covering the same receive node and improves communication reliability.

According to a second aspect, an embodiment provides a beacon sending method. The method includes: A first send node determines one or more subcarriers that are in a first frequency band, where the first frequency band is one of N frequency bands included in a first beacon resource of the first send node, and N is an integer greater than or equal to 1. The first send node sends a beacon signal on the one or more subcarriers.

The communication method may be performed by the first send node, or may be performed by a component (for example, a processor, a chip, or a chip system) of the first send node, or may be implemented by a logical module or software that can implement all or some functions of the first send node. The first send node may be a network device such as a satellite or a high-altitude platform, or may be a terminal device, or may be a ground station.

The foregoing method is used, so that the beacon signal and data transmission communication may use a unified standard, for example, an NR standard. A frequency band is configured for a beacon in a data transmission frequency band. A send node may send the beacon signal on one or more subcarriers that are in the frequency band configured for the beacon, so that beacon communication and the data transmission communication may use a same set of transceiver devices. This reduces hardware overheads and weights of the send node of the beacon signal and a receive node of the beacon signal. For example, hardware overheads and weights of a network device such as a satellite or a high-altitude platform and a terminal device such as a ground station can be reduced.

In a possible design, the beacon signal includes at least one of the following: a preset level signal, a preset modulation symbol, a reference signal used for navigation and/or measurement and control, measurement and control information, or the like. Optionally, a quantity of subcarriers sending the preset level signal or the preset modulation symbol is less than or equal to a preset threshold.

In the foregoing design, the beacon signal may be one or more of the following: the preset level signal, the preset modulation symbol, the reference signal used for navigation and/or measurement and control, the measurement and control information, or the like. Alternatively, a standard unified with that of the data transmission communication may be used for measurement and control signals, navigation signals, and the like. This reduces hardware overheads and weights of the send node of the beacon signal and the receive node of the beacon signal.

In a possible design, a non-cyclic prefix CP mode is used to send the preset level signal or the preset modulation symbol.

In the foregoing design, a preset level signal or a preset modulation symbol that occupies a small quantity of subcarriers is sent and received in a CP-free mode. This ensures phase continuity of a signal on the subcarrier and reduces inter-carrier interference to a data signal on a data transmission frequency band.

In a possible design, the method further includes: The first send node updates the first beacon resource to a third beacon resource based on coverage of the first send node, coverage of a second send node, and a second beacon resource. Optionally, the method further includes: The first send node sends first signaling to a first receive node, where the first signaling indicates to update the first beacon resource to the third beacon resource.

In the foregoing design, a beacon resource may be flexibly configured among a plurality of send nodes. Send nodes that do not cover a same receive node may reuse a same beacon resource. A plurality of send nodes that cover a same receive node may be updated through a beacon resource configuration, to avoid a collision of beacon resources.

In a possible design, before the first beacon resource is updated to the third beacon resource, the method further includes: The first send node determines that the first send node and the second send node cover the first receive node, and that the first beacon resource and the second beacon resource overlap in frequency domain.

In the foregoing design, the send node may determine whether the send nodes cover the same receive node and whether the beacon resources collide. When the send nodes cover the same receive node and the beacon resources collide, the beacon resource configuration is updated. This avoids a collision of the beacon resources and improves communication reliability.

In a possible design, before the first beacon resource is updated to the third beacon resource, the method further includes: The first send node receives second signaling from the first receive node, where the second signaling indicates that the beacon resources of the first send node and the second send node overlap in frequency domain.

In the foregoing design, the receive node may determine whether the send nodes cover the same receive node and whether the beacon resources collide. When the send nodes cover the same receive node and the beacon resources collide, the send node is requested to update the beacon resource configuration. This avoids a collision of the beacon resources among the send nodes covering the same receive node and improves communication reliability.

In a possible design, the method further includes: The first send node receives third signaling from a first receive node, where the third signaling indicates to update the first beacon resource to a third beacon resource. The first send node updates the first beacon resource to the third beacon resource.

In the foregoing design, when the receive node determines that the send nodes cover the same receive node and the beacon resources collide, the send node may be indicated on how to update the beacon resource configuration. This avoids a collision of the beacon resources among the send nodes covering the same receive node and improves communication reliability.

According to a third aspect, an embodiment provides a communication apparatus. The communication apparatus may include an interface unit and a processing unit. The processing unit is configured to determine one or more subcarriers that are in a first frequency band, where the first frequency band is one of N frequency bands included in a first beacon resource of a first send node, and N is an integer greater than or equal to 1. The interface unit is configured to receive a beacon signal on the one or more subcarriers. The processing unit is further configured to parse the beacon signal.

In a possible design, the beacon signal includes at least one of the following: a preset level signal, a preset modulation symbol, a reference signal used for navigation and/or measurement and control, or measurement and control information.

In a possible design, a quantity of subcarriers receiving the preset level signal or the preset modulation symbol is less than or equal to a preset threshold.

In a possible design, a non-cyclic prefix CP mode is used to receive the preset level signal or the preset modulation symbol.

In a possible design, the interface unit is further configured to receive first signaling from the first send node, where the first signaling indicates to update the first beacon resource to a third beacon resource. The processing unit is further configured to update the first beacon resource of the first send node to the third beacon resource.

In a possible design, the processing unit is further configured to determine that the first send node and a second send node cover the communication apparatus, and that the first beacon resource and a second beacon resource of the second send node overlap in frequency domain. The interface unit is further configured to send second signaling to the first send node, where the second signaling indicates that the beacon resources of the first send node and the second send node overlap in frequency domain.

In a possible design, the processing unit is further configured to determine that the first send node and a second send node cover the communication apparatus, and that the first beacon resource and a second beacon resource of the second send node overlap in frequency domain. The interface unit is further configured to send third signaling to the first send node, where the third signaling indicates to update the first beacon resource to a third beacon resource.

In a possible design, the processing unit is further configured to update the first beacon resource of the first send node to the third beacon resource.

According to a fourth aspect, an embodiment provides a communication apparatus. The communication apparatus may include an interface unit and a processing unit. The processing unit is configured to determine one or more subcarriers that are in a first frequency band, where the first frequency band is one of N frequency bands included in a first beacon resource of the communication apparatus, and N is an integer greater than or equal to 1. The interface unit is configured to send a beacon signal on the one or more subcarriers.

In a possible design, the beacon signal includes at least one of the following: a preset level signal, a preset modulation symbol, a reference signal used for navigation and/or measurement and control, or measurement and control information.

In a possible design, a quantity of subcarriers sending the preset level signal or the preset modulation symbol is less than or equal to a preset threshold.

In a possible design, a non-cyclic prefix CP mode is used to send the preset level signal or the preset modulation symbol.

In a possible design, the processing unit is further configured to update the first beacon resource to a third beacon resource based on coverage of the communication apparatus, coverage of a second send node, and a second beacon resource.

In a possible design, before updating the first beacon resource to the third beacon resource, the processing unit is further configured to determine that the communication apparatus and the second send node cover a first receive node, and that the first beacon resource and the second beacon resource overlap in frequency domain.

In a possible design, the interface unit is further configured to: before the processing unit updates the first beacon resource to the third beacon resource, receive second signaling from a first receive node, where the second signaling indicates that the beacon resources of the communication apparatus and the second send node overlap in frequency domain.

In a possible design, the interface unit is further configured to send first signaling to the first receive node, where the first signaling indicates to update the first beacon resource to the third beacon resource.

In a possible design, the interface unit is further configured to receive third signaling from a first receive node, where the third signaling indicates to update the first beacon resource to a third beacon resource. The processing unit is further configured to update the first beacon resource to the third beacon resource.

According to a fifth aspect, an embodiment provides a communication apparatus. The communication apparatus includes an interface circuit and a processor, and the processor and the interface circuit are coupled to each other. The processor is configured to implement, by using a logic circuit or by executing code instructions, the method in any one of the first aspect or the possible designs of the first aspect. The interface circuit is configured to receive a signal from a communication apparatus other than the communication apparatus and transmit the signal to the processor, or send a signal from the processor to a communication apparatus other than the communication apparatus. It may be understood that the interface circuit may be a transceiver, transceiver machine, receiver/transmitter, or an input/output interface.

Optionally, the communication apparatus may further include a memory, configured to store instructions executed by the processor, or store input data required by the processor to run instructions, or store data generated after the processor runs instructions. The memory may be a physically independent unit, or may be coupled to the processor, or the processor includes the memory.

According to a sixth aspect, an embodiment provides a communication apparatus. The communication apparatus includes an interface circuit and a processor, and the processor and the interface circuit are coupled to each other. The processor is configured to implement, by using a logic circuit or by executing code instructions, the method in any one of the second aspect or the possible designs of the second aspect. The interface circuit is configured to receive a signal from a communication apparatus other than the communication apparatus and transmit the signal to the processor, or send a signal from the processor to a communication apparatus other than the communication apparatus. It may be understood that the interface circuit may be a transceiver, transceiver machine, receiver/transmitter, or an input/output interface.

Optionally, the communication apparatus may further include a memory, configured to store instructions executed by the processor, or store input data required by the processor to run instructions, or store data generated after the processor runs instructions. The memory may be a physically independent unit, or may be coupled to the processor, or the processor includes the memory.

According to a seventh aspect, an embodiment provides a communication system. The communication system includes a first receive node and a first send node. The first receive node may implement the method in any one of the first aspect or the possible designs of the first aspect, and the first send node may implement the method in any one of the second aspect or the possible designs of the second aspect.

According to an eighth aspect, an embodiment provides a computer-readable storage medium. The storage medium stores a computer program or instructions. When the computer program or the instructions are executed, the method in any one of the first aspect or the possible designs of the first aspect, or the method in any one of the second aspect or the possible designs of the second aspect may be implemented.

According to a ninth aspect, an embodiment provides a computer program product, including a computer program or instructions. When the computer program or the instructions are executed, the method in any one of the first aspect or the possible designs of the first aspect, or the method in any one of the second aspect or the possible designs of the second aspect may be implemented.

According to a tenth aspect, an embodiment provides a chip. The chip is coupled to a memory, and is configured to read and execute a program or instructions stored in the memory, to implement the method in any one of the first aspect or the possible designs of the first aspect, or the method in any one of the second aspect or the possible designs of the second aspect.

For technical effects that can be achieved in the third aspect to the tenth aspect, refer to technical effects that can be achieved in the first aspect or the second aspect. Details are not described herein again.

### BRIEF DESCRIPTION OF DRAWINGS

FIG. 1 is a schematic diagram of an architecture of a communication system according to an embodiment;

FIG. 2 is a schematic diagram of a communication method according to an embodiment;

FIG. 3 is a schematic diagram of a bandwidth and a resource in a beacon mode 1 according to an embodiment;

FIG. 4 is a schematic diagram of a bandwidth and a resource in a beacon mode 3 according to an embodiment;

FIG. 5 is a first schematic diagram of coverage of a send node according to an embodiment;

FIG. 6 is a second schematic diagram of coverage of a send node according to an embodiment;

FIG. 7 is a first schematic diagram of a beacon resource update process according to an embodiment;

FIG. 8 is a second schematic diagram of a beacon resource update process according to an embodiment;

FIG. 9 is a third schematic diagram of a beacon resource update process according to an embodiment;

FIG. 10 is a first schematic diagram of a communication apparatus according to an embodiment; and

FIG. 11 is a second schematic diagram of a communication apparatus according to an embodiment.

### DESCRIPTION OF EMBODIMENTS

The technical solutions in embodiments of the present disclosure may be applied to various communication systems, for example, a 5G system, an NTN system, a global system for mobile communications (GSM) system, an enhanced data rate for GSM evolution (EDGE) system, a wideband code division multiple access (WCDMA) system, a code division multiple access (CDMA) 2000 system, a time division-synchronous code division multiple access (TD-SCDMA) system, a long term evolution (LTE) system, a narrow band Internet of Things (NB-IoT) system, and a satellite communication system, or may be applied to a future communication system, for example, a 6th generation (6G) communication system. The 5G system may be applied to an enhanced mobile broadband (eMBB) system, an ultra-reliable & low-latency communication (URLLC) system, a massive machine type communication (eMTC) system, and the like in the 5G system.

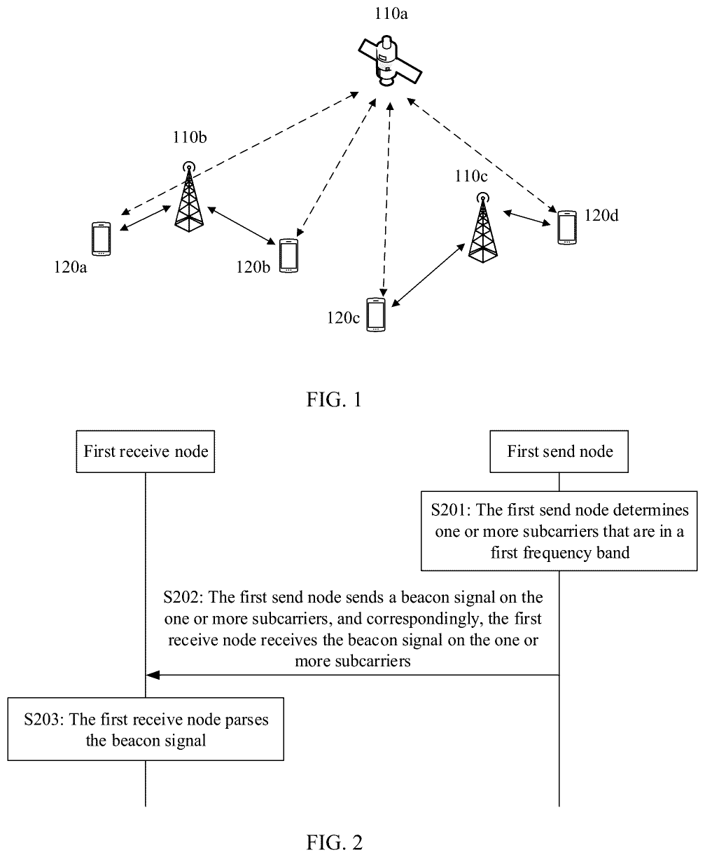

FIG. 1 is a schematic diagram of an architecture of a communication system to which an embodiment is applied. As shown in FIG. 1, the communication system includes at least one network device, for example, 110a, 110b, and 110c in FIG. 1, and may further include at least one terminal device, for example, 120a to 120d in FIG. 1. Herein, 110a is an air base station, for example, a high-altitude platform, a high-altitude aircraft, or a satellite, and 110b and 110c are ground base stations. It should be understood that FIG. 1 is merely a schematic diagram. The communication system may include network devices or terminal devices of a larger or smaller quantity, and may further include another device, for example, may further include a wireless relay device and a wireless backhaul device that are not shown in FIG. 1.

The network device may also be referred to as an access network (AN) device or a radio access network (RAN) device, and is an apparatus or a device that may be deployed in a radio access network to provide a wireless communication function for the terminal device. For example, the network device may be a base station (BS), a NodeB, an evolved NodeB (eNodeB), a transmission reception point (TRP), a satellite, a high-altitude platform or a high-altitude platform station (HAPS), a next-generation NodeB (gNB) in a 5G system, a base station in a 6G system, a base station in another future mobile communication system, or the like; or may be a module or a unit that performs some functions of a base station, for example, may be a central unit (CU) or a distributed unit (DU). The CU herein implements functions of a radio resource control protocol and a packet data convergence protocol (PDCP) of the base station, and may further implement functions of a service data adaptation protocol (SDAP). The DU implements functions of a radio link control layer and a medium access control (MAC) layer of the base station, and may further implement functions of some or all physical layers. For specific descriptions of the foregoing protocol layers, refer to technical specifications related to the 3rd generation partnership project (3GPP). The network device may be a macro base station, or may be a micro base station or an indoor base station, or may be a relay station (or a relay node), a donor node, an access point, or the like. A specific technology and a specific device form that are used by the network device are not limited in embodiments of the present disclosure. It may be understood that all or some functions of the network device may also be implemented by using a software function running on hardware, or may be implemented by using a virtualization function instantiated on a platform (for example, a cloud platform).

In addition, the network device may include a baseband unit (BBU) and a remote radio unit (RRU). The RRU and the BBU respectively bear a radio frequency processing part and a baseband processing part of the network device. Optical fiber transmission may be used between the BBU and the RRU to implement remote RRU transmission. For example, the RRU may be placed in a high-traffic area, and the BBU may be placed in a central equipment room. Certainly, the BBU and the RRU may alternatively be placed in a same equipment room or be different components in a same rack.

The terminal device may also be referred to as a terminal, user equipment (UE), a mobile station (MS), a mobile terminal, or the like, and is an apparatus or a device having a wireless communication function. The terminal device may be widely used in various scenarios, for example, MTC, Internet of Things (IoT), virtual reality, augmented reality, industrial control, self-driving, telemedicine, a smart grid, smart furniture, smart office, smart wear, smart transportation, and a smart city. The terminal device may be a subscriber unit, a cellular phone, a smartphone, a wireless data card, a personal digital assistant (PDA) computer, a tablet computer, a wireless modem, a handheld device (handset), a laptop computer, a wearable device, a vehicle, an uncrewed aerial vehicle, a helicopter, an aircraft, a ship, a robot, a mechanical arm, a smart home device, an MTC device, a ground station, or the like. A specific technology and a specific device form that are used by the terminal device are not limited in embodiments of the present disclosure.

The network device and the terminal device may be located at a fixed position or may be mobile. The network device and the terminal device may be deployed on land, including an indoor or outdoor scenario and a handheld or vehicle-mounted scenario, or may be deployed on water, or may be deployed on an airplane, a balloon, and a satellite in the air. An application scenario of the network device and the terminal device is not limited in this embodiment.

Communication may be performed between the network device and the terminal device, the network device and the network device, and the terminal device and the terminal device by using a licensed spectrum, an unlicensed spectrum, or both a licensed spectrum and an unlicensed spectrum; or may be performed by using a spectrum below 6 gigahertz (GHz), a spectrum above 6 GHz, or both a spectrum below 6 GHz and a spectrum above 6 GHz. A spectrum resource used for wireless communication is not limited in embodiments of the present disclosure.

In embodiments of the present disclosure, the function of the network device may alternatively be performed by a module (for example, a chip) in the network device, or may be performed by a control subsystem including the function of the network device. The control subsystem including the function of the network device may be a control center in the foregoing application scenarios such as a smart grid, industrial control, smart transportation, and a smart city. The function of the terminal device may alternatively be performed by a module (for example, a chip or a modem) in the terminal device, or may be performed by an apparatus including the function of the terminal device.

In this application, the network device sends a downlink signal or downlink information to the terminal device. The downlink information is carried on a downlink channel. The terminal device sends an uplink signal or uplink information to the network device. The uplink information is carried on an uplink channel. A time domain symbol may be an orthogonal frequency division multiplexing (OFDM) symbol, or may be a discrete Fourier transform spread OFDM (DFT-s-OFDM) symbol, or may be a waveform signal of another type. Unless otherwise specified, symbols in embodiments of the present disclosure are time domain symbols.

A beacon signal may alternatively be referred to as a beacon for short. The beacon signal is usually a continuous or periodic radio signal with limited information content (for example, an identifier or a location of a transceiver) transmitted by a transceiver at a known location at a frequency specified by the transceiver. At present, a beacon resource for sending the beacon signal by a satellite or a high-altitude platform needs to be applied to the International Amateur Radio Union (IARU), and is a dedicated fixed frequency. Once the satellite or the high-altitude platform is launched, the beacon resource cannot be replaced. As a quantity of satellites or high-altitude platforms increases rapidly, for a large-scale low-earth orbit satellite system, an inter-satellite topology dynamically changes. If a specific beacon resource is applied for each satellite or high-altitude platform, the beacon resource is insufficient. In addition, a dedicated fixed frequency is applied for a satellite or a high-altitude platform in a pre-divided beacon spectrum resource, and a standard used to send a beacon signal cannot be compatible with data transmission communication, for example, cannot be compatible with a new radio (NR) system. A network device such as a satellite or a high-altitude platform and a terminal device such as a ground station need to deploy a plurality of sets of hardware devices such as a measurement and control device and a communication device. This not only increases hardware costs of the network device such as the satellite or the high-altitude platform and the terminal device such as the ground station, but also increases a weight of the network device such as the satellites or the high-altitude platform.

Therefore, the present disclosure provides beacon sending and receiving methods, to implement integration of beacon communication and data transmission communication, and to reduce hardware overheads and weights of a network device such as a satellite or a high-altitude platform and a terminal device such as a ground station.

The following describes in detail embodiments of the present disclosure with reference to the accompanying drawings. In embodiments of the present disclosure, a send node may be a network device (for example, a satellite or a high-altitude platform), and a receive node may be a terminal device (for example, a ground station); or the send node is a terminal device, and the receive node is a network device. The network device may alternatively be a device or a component that has a function of the network device, or a chip (for example, a processor or a chip system) used in the network device. The terminal device may alternatively be a device or a component that has a function of the terminal device, or a chip (for example, a processor or a chip system) used in the terminal device.

In addition, it should be understood that, ordinal numerals such as “first” and “second” mentioned in embodiments of the present disclosure are intended to distinguish between a plurality of objects, and are not intended to limit sizes, content, orders, time sequences, priorities, or importance degrees of the plurality of objects. For example, a first threshold and a second threshold may be a same threshold, or may be different thresholds. In addition, such a name does not indicate a difference of values, corresponding parameters, priorities, importance degrees, or the like between the two thresholds.

In embodiments of the present disclosure, unless otherwise specified, the number of a noun represents “a singular noun or a plural noun”, that is, “one or more”. “At least one” means one or more, and “a plurality of” means two or more. “And/or” describes an association relationship between associated objects and represents that three relationships may exist. For example, A and/or B may represent the following cases: Only A exists, both A and B exist, and only B exists, where A and B may be singular or plural. The character “/” generally indicates an “or” relationship between the associated objects. For example, A/B represents A or B. “At least one of the following items” or a similar expression thereof means any combination of these items, including a singular item or any combination of plural items. For example, at least one of a, b, or c may indicate a, b, c, a and b, a and c, b and c, or a, b, and c, where a, b, and c may indicate a singular or plural form.

FIG. 2 is a schematic diagram of a communication method according to an embodiment. The method includes the following steps.

S201: A first send node determines one or more subcarriers that are in a first frequency band.

The first frequency band is one of N frequency bands included in a first beacon resource of the first send node, and N is an integer greater than or equal to 1.

S202: The first send node sends a beacon signal on the one or more subcarriers, and correspondingly, a first receive node receives the beacon signal on the one or more subcarriers.

S203: The first receive node parses the beacon signal.

In embodiments of the present disclosure, a plurality of beacon modes may be set, to send and receive different types of beacon signals. For example, a beacon mode such as an unmodulated single-carrier beacon mode (beacon mode 1), a modulated single-carrier beacon mode (beacon mode 2), and a modulated multi-carrier beacon mode (beacon mode 3) may be set, to send and receive a beacon signal of an unmodulated single-carrier type, a beacon signal of a modulated single-carrier type, a beacon signal of a modulated multi-carrier type, and the like. Different beacon modes may correspond to different bandwidths and frequency domain resource configurations, or may use different beacon signal sending modes. The following describes the foregoing three beacon modes in detail from aspects of bandwidths and frequency resource configurations for sending a beacon signal, a beacon signal sending mode, and the like.

### Beacon Mode 1

Bandwidth and frequency resource configuration: In the beacon mode 1, a beacon frequency band may be defined, for example, a beacon frequency band 1 (a BW_beacon1). In the BW_beacon1, one or more subcarriers configured at a spacing may be used to carry a beacon signal, and another subcarrier is a beacon guard band. Alternatively, the BW_beacon1 may be a group of frequency domain resources including a plurality of subbands (namely, sub-bands), one subcarrier in each sub-band may be used to carry a beacon signal, and another subcarrier is a beacon guard band.

CP length: In the beacon mode 1, it may be defined to use a CP-free mode to send a beacon signal. For example, that a CP whose CP length is 0 is added is used as a CP-free mode, and the beacon mode 1 uses the CP whose CP length is 0, in other words, the beacon signal is sent in the CP-free mode. The beacon signal and an NR data signal may use a same baseband module.

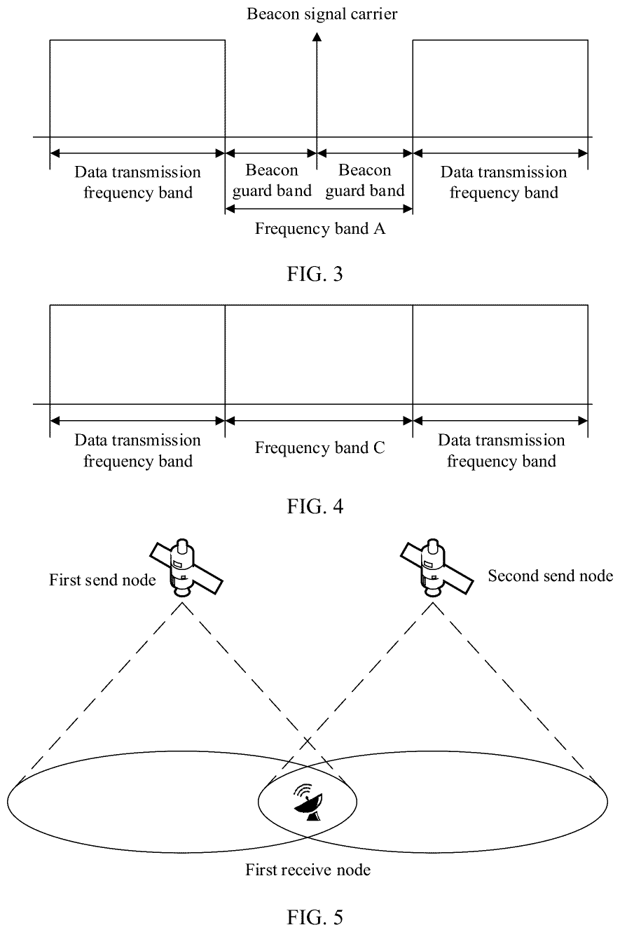

FIG. 3 is a schematic diagram of a frequency band in the beacon mode 1 according to an embodiment. For example, a frequency band A is used. The frequency band A may occupy a segment of frequency domain resource in a data transmission frequency domain resource. A bandwidth of the frequency band A is a bandwidth of the segment of frequency domain resource occupied by the frequency band A. One subcarrier in the frequency band A is used to carry a beacon signal, and another subcarrier is a beacon guard band. The another subcarrier does not carry the beacon signal, and is used to avoid interference between the beacon signal and a data signal carried by a data transmission frequency band.

The subcarrier in the frequency band of the beacon mode 1 may be used to carry the beacon signal such as a preset level signal or a preset modulation symbol. The preset level signal may be a level signal that keeps being 1, or the like. The preset modulation symbol may be +1 or −1 in binary phase shift keying (BPSK) modulation, or a+aj, a−aj, a+aj, a—aj, or the like in quadrature phase shift keying (QPSK) modulation, where a is equal to

$$\frac{\sqrt{2}}{2} ,$$

j is an imaginary unit, and j*j=−1. The level signal that keeps being 1 may be a sine wave signal with a constant amplitude, and may be understood as that no information is carried. A signal sent in the beacon mode 1 may be used for antenna alignment and the like.

The beacon signal carried by the subcarrier that is in the frequency band of the beacon mode 1 may be sent in the CP-free mode, and OFDM symbols carrying beacon signals are concatenated in the CP-free mode, so that phase continuity of the beacon signal on the carrier can be ensured. In addition, the beacon signal with a continuous phase has a cyclic convolution feature, and the CP-free beacon signal has no inter-carrier interference to the data signal.

### Beacon Mode 2

Bandwidth and frequency resource configuration: In the beacon mode 2, a beacon frequency band may be defined, for example, a beacon frequency band 2 (a BW_beacon2). Similar to that in the BW_beacon1, in the BW_beacon2, one or more subcarriers configured at a spacing may be used to carry a beacon signal, and another subcarrier is a beacon guard band. Alternatively, the BW_beacon2 may be a group of frequency domain resources including a plurality of subbands, one subcarrier in each sub-band may be used to carry a beacon signal, and another subcarrier is a beacon guard band.

CP length: In the beacon mode 2, it may be defined to use a normal CP or an extended CP defined in an NR standard. The beacon signal and an NR data signal may use a same baseband module.

The subcarrier in the frequency band of the beacon mode 2 may be used to carry a reference signal used for navigation and/or measurement and control, measurement and control information, or the like. The beacon signal sent in the beacon mode 2 may be used for antenna alignment, transmission of a small quantity or some of the measurement and control information, or the like. For example, different send nodes may send different reference signals (or reference sequences) to a receive node on different subcarriers in the beacon mode 2, so that the receive node performs antenna alignment and send node identification for a plurality of send nodes.

### Beacon Mode 3

Bandwidth and frequency resource configuration: In the beacon mode 3, a beacon frequency band may be defined, for example, a beacon frequency band 3 (a BW_beacon3). In the BW_beacon3, a plurality of consecutive subcarriers may be used to carry a beacon signal.

CP length: In the beacon mode 3, it may be defined to use a normal CP or an extended CP defined in an NR standard. The beacon signal and an NR data signal may use a same baseband module.

FIG. 4 is a schematic diagram of a frequency band in the beacon mode 3 according to an embodiment. For example, a frequency band C is used. The frequency band C may occupy a segment of frequency domain resource in a data transmission frequency domain resource. A bandwidth of the frequency band C is a bandwidth of the segment of frequency domain resource occupied by the frequency band C. A plurality of consecutive subcarriers in the frequency band C may be used to carry a beacon signal.

The plurality of consecutive subcarriers in the frequency band of the beacon mode 3 may be used to carry measurement and control information. Compared with the measurement and control information carried by the subcarrier that is in the frequency band of the beacon mode 2, a quantity of pieces of measurement and control information carried by the plurality of consecutive subcarriers that are in the frequency band of the beacon mode 3 may be greater. For example, when a data amount of the measurement and control information is less than or equal to a first threshold, the frequency band of the beacon mode 2 may be used for sending; or when a data amount of the measurement and control information is greater than a first threshold, the frequency band of the beacon mode 3 may be used for sending.

In embodiments of the present disclosure, a corresponding beacon resource may be configured (or applied to) for each send node, and the beacon resource may include frequency bands of one or more beacon modes.

In an example, the first beacon resource configured for the first send node includes three frequency bands: a frequency band A1, a frequency band B1, and a frequency band C1. The frequency band A1 is a frequency band of the beacon mode 1, the frequency band B1 is a frequency band of the beacon mode 2, and the frequency band C1 is a frequency band of the beacon mode 3. In addition, it should be understood that, in embodiments of the present disclosure embodiments of the present disclosure, frequency bands of more or fewer beacon modes may be configured for the send node according to a service requirement of the send node. For example, for a send node that does not require measurement and control information transmission, a beacon resource configured for the send node may include only a frequency band of the beacon mode 1 and a frequency band of the beacon mode 2.

Still, in an example, the beacon resource configured for the first send node includes the frequency band A1, the frequency band B1, and the frequency band C1. When a terminal device needs to send a beacon signal, the first send node may select a corresponding frequency band based on a specific type of the beacon signal that needs to be sent, and determine, in the selected frequency band, one or more subcarriers sending the beacon signal. One or more subcarriers that may be used to send the beacon signal and that are in each frequency band may be configured when the first beacon resource is configured for the first send node. Alternatively, a subcarrier selection rule may be predefined for a frequency band of each beacon mode, and the first send node and the corresponding receive node may also determine, according to the rule, one or more subcarriers that may be used to send the beacon signal and that are in the frequency band.

In an example, the beacon signal is a preset level signal. The first send node may select the frequency band A1 from the frequency band A1, the frequency band B1, and the frequency band C1 as a frequency band for sending the beacon signal, determine one or more subcarriers that may be used to send the beacon signal and that are in the frequency band A1, and send the beacon signal on the determined one or more subcarriers. Correspondingly, the first receive node receives the beacon signal on the one or more subcarriers, and may parse the received beacon signal. For example, a direction of a receive antenna is continuously adjusted, to maximize a power of the received signal on a corresponding frequency (or subcarrier), upon which the antenna is aligned with the first send node.

In an example, the beacon signal is the measurement and control information, such as a picture taken by a satellite or data monitored by the satellite. The data amount of the measurement and control information is greater than the first threshold. The first send node may select the frequency band C1 from the frequency band A1, the frequency band B1, and the frequency band C1 as a frequency band for sending the beacon signal, determine a plurality of subcarriers that may be used to send the beacon signal and that are in the frequency band C1, and send the beacon signal on the determined plurality of subcarriers. Correspondingly, the first receive node receives the beacon signal on the plurality of subcarriers, and may parse the beacon signal to obtain the measurement and control information, for example, obtain the picture taken by the satellite or the data monitored by the satellite.

It should be understood that, a manner in which the first receive node determines the one or more subcarriers that may be used to send the beacon signal and that are in the frequency band is similar to that of the first send node, for example, may be determined based on configuration information of the one or more subcarriers that may be used to send the beacon signal, that are in each frequency band, and that are configured in the first beacon resource of the first send node, or may be determined according to the subcarrier selection rule predefined for the frequency band of each beacon mode.

It should be understood that, in embodiments of the present disclosure embodiments of the present disclosure, a quantity of subcarriers sending the preset level signal or the preset modulation symbol may be less than or equal to a preset threshold, for example, less than or equal to 2. In an example, it may be configured that a quantity of subcarriers that may be used to send the beacon signal and that are in the frequency band of the beacon mode 1 is less than or equal to the preset threshold, to limit the quantity of subcarriers sending the preset level signal or the preset modulation symbol.

For a constellation including a plurality of send nodes, if a beacon resource is applied to (or configured) for each send node in the constellation, beacon resource overheads are huge. To save beacon resources, in embodiments of the present disclosure embodiments of the present disclosure, the beacon resource of the send node may be configurable (Beacon_config), and the beacon resource may be reused between a plurality of send nodes. In other words, one beacon resource may be used by one or more send nodes at the same time.

In an example, six beacon resources (a beacon resource A, a beacon resource B, . . . , a beacon resource E, and a beacon resource F) may be reused between 16 send nodes (a send node 1, a send node 2, a send node 3, . . . , a send node 15, and a send node 16). At a moment, the beacon resource A is used by the send node 1, the send node 3, the send node 7, and the send node 9, the beacon resource B is used by the send node 2, the send node 4, the send node 8, and the send node 10, the beacon resource C is used by the send node 5, the send node 11, the send node 13, and the send node 15, and the beacon resource D is used by the send node 6, the send node 12, the send node 14, and the send node 16. The beacon resource E and the beacon resource F are temporarily in an idle state, and are not used by the send node.

It should be understood that, in embodiments of the present disclosure, any two different beacon resources in a plurality of beacon resources configured or applied to for the constellation including the plurality of send nodes may not overlap in frequency domain, or may partially overlap in frequency domain. For a beacon resource initially used by the send node, a manner such as a default configuration (beacon_default) may be used. When the send node initially accesses a network or before the send node accesses the network, a beacon resource (for example, a default beacon resource) is selected for the send node from the plurality of beacon resources in the constellation in which the send node is located as an initial beacon resource. In addition, for ease of description, in subsequent descriptions of embodiments of the present disclosure, an example in which any two different beacon resources in the plurality of beacon resources configured or applied to for the constellation including the plurality of send nodes do not overlap in frequency domain is used for description.

In addition, a topology of the constellation including the plurality of send nodes dynamically changes. Therefore, areas covered by the plurality of send nodes may overlap at a moment or in a time period, and a same beacon resource is reused. The beacon resources overlap in frequency domain, and a collision occurs. In embodiments of the present disclosure, to avoid a collision between the beacon resources of the send nodes, where the collision affects receiving and parsing of the beacon signal by the receive node, a beacon resource configuration of the send node may be dynamically updated in a manner such as an active update of the send node or an indication update of the receive node, to avoid the collision between the beacon resources of the send nodes. The following uses an example in which the first beacon resource of the first send node is updated for description.

Manner 1: The first send node updates the first beacon resource to a third beacon resource based on coverage of the first send node, coverage of a second send node, and a second beacon resource.

There may be one or more second send nodes. The second send node may be any send node in a constellation in which the first send node is located other than the first send node, or a send node that is in a constellation in which the first send node is located and that is closest to the coverage of the first send node, or all send nodes in a constellation in which the first send node is located other than the first send node.

For example, the second send node is a send node that is in a constellation in which the first send node is located and that is closest to the coverage of the first send node. The first send node may interact with other send nodes in the constellation in which the first send node is located, to obtain coverage of the other send nodes in the constellation and information about a beacon resource that is used, and may select, from the other send nodes in the constellation based on the coverage of the other send nodes in the constellation and the coverage of the first send node, a send node whose coverage is closest to the coverage of the first send node, serving as a second send node. After the second send node is determined, the first send node may update the first beacon resource of the first send node to the third beacon resource based on the coverage of the second send node and the second beacon resource that is used. For example, the first send node may select one of the plurality of beacon resources in the constellation in which the first send node is located as the third beacon resource, and update the first beacon resource used by the first send node to the third beacon resource.

It should be understood that, if the coverage of the first send node and the coverage of the second send node overlap, for example, both cover a receive node, and the first beacon resource and the second beacon resource overlap in frequency domain, the updated third beacon resource of the first send node is different from the first beacon resource. If the coverage of the first send node and the coverage of the second send node do not overlap, or the first beacon resource and the second beacon resource do not overlap in frequency domain, the updated third beacon resource of the first send node may be the same as the first beacon resource, that is, the first beacon resource before updating of the first send node and the updated third beacon resource may be a same beacon resource.

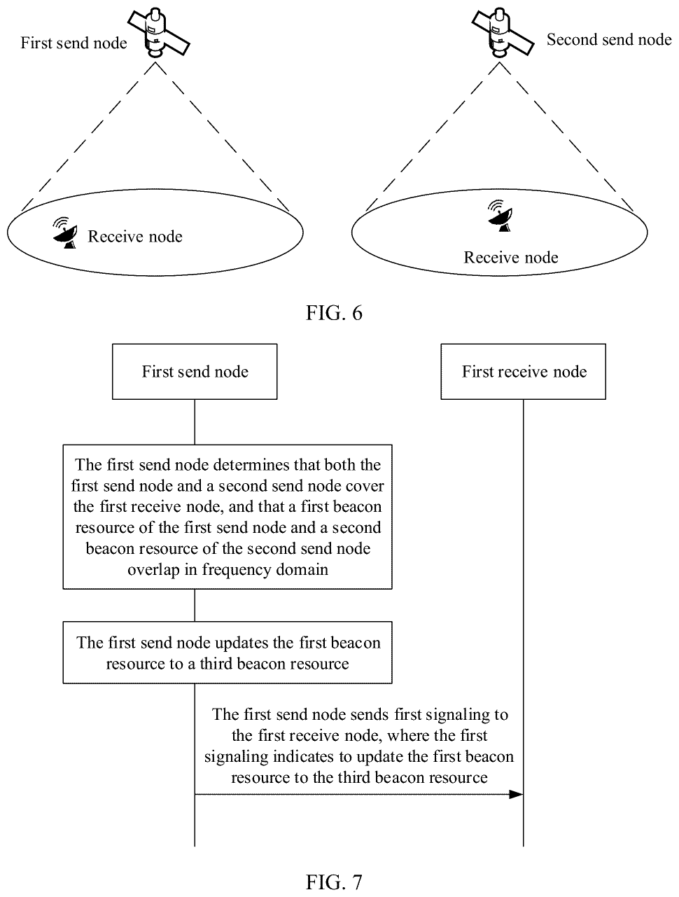

In an example, as shown in FIG. 5, both the first send node and the second send node cover the first receive node, and the first beacon resource of the first send node and a beacon resource of the second send node overlap in frequency domain. The updated third beacon resource of the first send node is a beacon resource that is different from the first beacon resource and that does not overlap the second beacon resource in frequency domain. As shown in FIG. 6, coverage of the first send node and the second send node do not overlap. Even if the first beacon resource of the first send node and the beacon resource of the second send node overlap in frequency domain, for example, the first beacon resource is the same as the second beacon resource, the updated third beacon resource of the first send node may still use the previous first beacon resource.

In addition, to prevent the first send node from frequently updating the first beacon resource that is used, a beacon resource update cycle may be set. The first send node may update the first beacon resource to the third beacon resource based on the beacon resource update cycle and based on the coverage of the first send node, the coverage of the second send node, and the second beacon resource.

Manner 2: The first send node determines that the first send node and a second send node cover the first receive node, and that the first beacon resource and the second beacon resource overlap in frequency domain. The first send node updates the first beacon resource to a third beacon resource based on coverage of the first send node, coverage of a second send node, and a second beacon resource.

As shown in FIG. 7, the first send node may interact with other send nodes in a constellation in which the first send node is located, to obtain coverage of the other send nodes in the constellation and information about a beacon resource that is used, and determine whether the first send node and the other send nodes cover a same receive node and beacon resources overlap in frequency domain. If the first send node determines that both the first send node and the second send node in the constellation cover the first receive node, and the first beacon resource of the first send node and the second beacon resource of the second send node overlap in frequency domain, the first send node updates the first beacon resource to a third beacon resource that does not overlap the second beacon resource in frequency domain. The first send node may select, from the plurality of beacon resources in the constellation in which the first send node is located, a beacon resource that does not overlap the second beacon resource in frequency domain as the third beacon resource.

In addition, to help a receive node within the coverage of the first send node learn the updated third beacon resource that is used and that is of the first send node, after updating the first beacon resource to the third beacon resource, the first send node may further send first signaling (for example, beacon resource configuration indication signaling). The first signaling indicates to update the first beacon resource to the third beacon resource. For example, the first signaling may carry an identifier of the first send node and an identifier of the third beacon resource, indicating to update the first beacon resource currently used by the first send node to the third beacon resource.

In an example, after updating the first beacon resource to the third beacon resource, the first send node may send the first signaling to the first receive node within the coverage of the first send node. The first signaling may carry the identifier of the first send node and the identifier of the third beacon resource, indicating to update the first beacon resource currently used by the first send node to the third beacon resource. After the first signaling is received by the first receive node, the stored first beacon resource of the first send node is updated to the third beacon resource, to receive the beacon signal from the first send node based on the third beacon resource.

Manner 3: The first send node receives second signaling from the first receive node. The second signaling indicates that the beacon resources of the first send node and the second send node overlap in frequency domain. The first send node updates the first beacon resource to a third beacon resource based on a second beacon resource of a second send node.

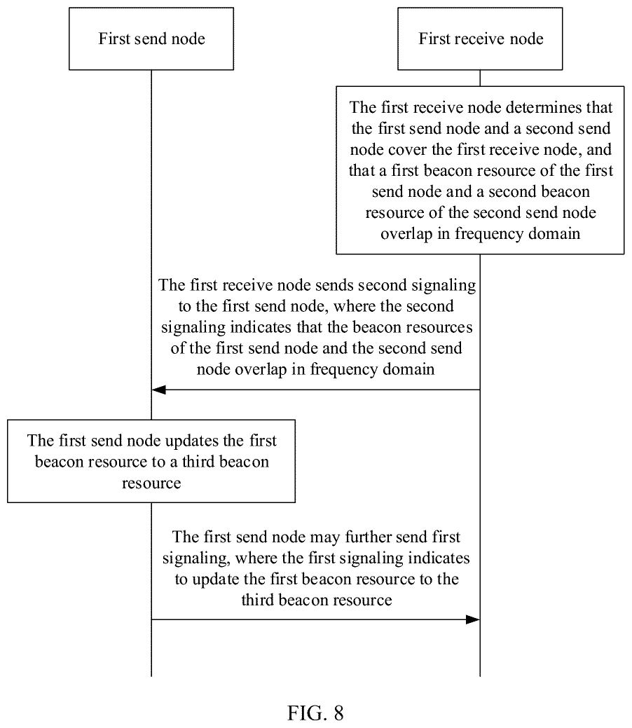

As shown in FIG. 8, the first receive node determines, based on ephemerides of the first send node and the second send node and information about beacon resources delivered by the first send node and the second send node, that the first send node and the second send node cover the first receive node, and that the first beacon resource of the first send node and the second beacon resource of the second send node overlap in frequency domain. The first receive node may send the second signaling (for example, beacon resource configuration update request signaling) to the first send node. The second signaling may carry an identifier of the second send node, indicating that the beacon resources of the first send node and the second send node overlap in frequency domain.

After the second signaling from the first receive node is received by the first send node, the first beacon resource of the first send node is updated, based on the second beacon resource of the second send node, to the third beacon resource that does not overlap the second beacon resource in frequency domain.

In addition, to help a receive node within the coverage of the first send node learn the updated third beacon resource that is used and that is of the first send node, after updating the first beacon resource to the third beacon resource, the first send node may further send first signaling (for example, beacon resource configuration indication signaling) to the receive node within the coverage of the first send node, for example, the first receive node. The first signaling may indicate to update the first beacon resource to the third beacon resource. After the first signaling is received by the first receive node, the stored first beacon resource of the first send node is updated to the third beacon resource, to receive the beacon signal from the first send node based on the third beacon resource.

Manner 4: The first send node receives third signaling from the first receive node. The third signaling indicates to update the first beacon resource to a third beacon resource. The first send node updates the first beacon resource to the third beacon resource.

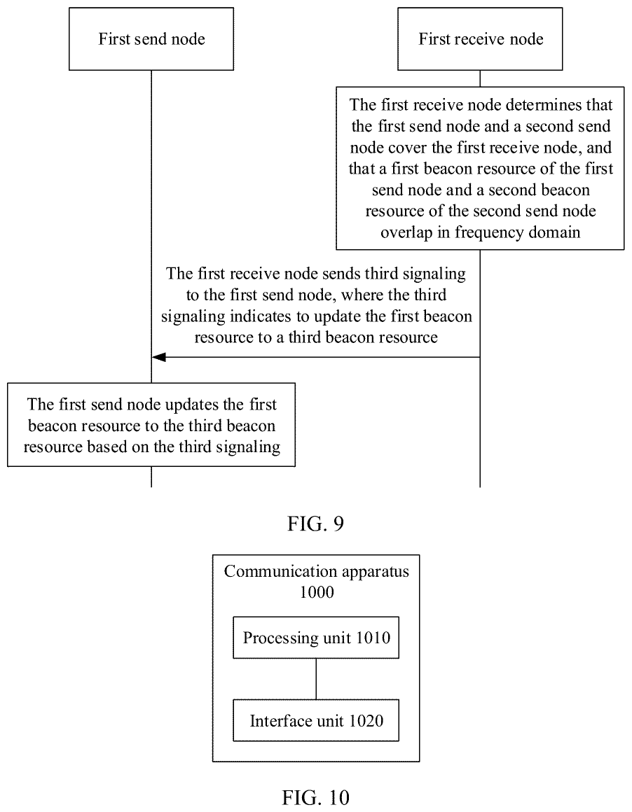

As shown in FIG. 9, the first receive node may determine, based on the ephemerides of the first send node and the second send node and information about beacon resources delivered by the first send node and the second send node, that after the first send node and the second send node cover the first receive node, and the first beacon resource of the first send node and the second beacon resource of the second send node overlap in frequency domain, the first receive node may determine, for the first send node, a third beacon resource that does not overlap the second beacon resource in frequency domain, and send, to the first send node, third signaling (for example, beacon resource configuration update indication signaling) that indicates to update the first beacon resource to the third beacon resource. In addition, the first receive node may further update the stored first beacon resource of the first send node to the third beacon resource, to receive the beacon signal from the first send node based on the third beacon resource.

After the third signaling is received by the first send node, the first beacon resource may be updated to the third beacon resource based on the third signaling, and the beacon signal is sent by using the third beacon resource.

In an example, the third signaling may carry an identifier of the third beacon resource, to indicate to update the first beacon resource to the third beacon resource.

It may be understood that, to implement functions in the foregoing embodiments, the first receive node and the first send node include corresponding hardware structures and/or software modules for performing the functions. A person skilled in the art should be easily aware that embodiments can be implemented by hardware or a combination of hardware and computer software in combination with the units and the method steps in the examples described in embodiments disclosed herein. Whether a function is performed by hardware or hardware driven by computer software depends on particular application scenarios and design constraints of technical solutions.

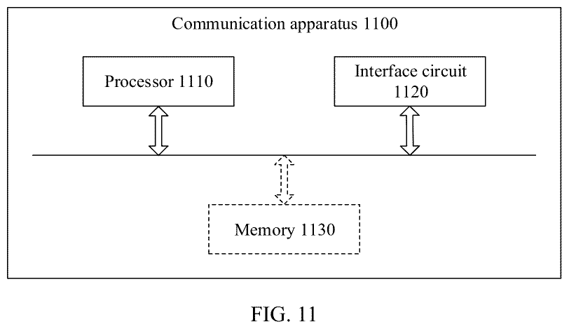

FIG. 10 and FIG. 11 are schematic diagrams of possible structures of communication apparatuses according to embodiments of the present disclosure. These communication apparatuses may be configured to implement functions of the first receive node or the first send node in the foregoing method embodiments, and therefore beneficial effects of the foregoing method embodiments can also be implemented. In a possible implementation, the communication apparatus may be the network device shown in FIG. 1, or may be the terminal device shown in FIG. 1, or may be a module (for example, a chip) used in the network device or the terminal device.

As shown in FIG. 10, the communication apparatus 1000 includes a processing unit 1010 and an interface unit 1020. The interface unit 1020 may alternatively be a transceiver unit or an input/output interface. The communication apparatus 1000 may be configured to implement functions of the first receive node or the first send node in the method embodiment shown in FIG. 2, FIG. 7, FIG. 8, or FIG. 9.

When the communication apparatus 1000 is configured to implement the functions of the first receive node in the method embodiment shown in FIG. 2, FIG. 7, FIG. 8, or FIG. 9:

the processing unit 1010 is configured to determine one or more subcarriers that are in a first frequency band, where the first frequency band is one of N frequency bands included in a first beacon resource of a first send node, and N is an integer greater than or equal to 1;

the interface unit 1020 is configured to receive a beacon signal on the one or more subcarriers; and

the processing unit 1010 is further configured to parse the beacon signal.

In a possible design, the beacon signal includes at least one of the following: a preset level signal, a preset modulation symbol, a reference signal used for navigation and/or measurement and control, or measurement and control information.

In a possible design, a quantity of subcarriers receiving the preset level signal or the preset modulation symbol is less than or equal to a preset threshold.

In a possible design, a CP mode is used to receive the preset level signal or the preset modulation symbol.

In a possible design, the interface unit 1020 is further configured to receive first signaling from the first send node, where the first signaling indicates to update the first beacon resource to a third beacon resource. The processing unit 1010 is further configured to update the first beacon resource of the first send node to the third beacon resource.

In a possible design, the processing unit 1010 is further configured to determine that the first send node and a second send node cover the communication apparatus, and that the first beacon resource and a second beacon resource of the second send node overlap in frequency domain. The interface unit 1020 is further configured to send second signaling to the first send node, where the second signaling indicates that the beacon resources of the first send node and the second send node overlap in frequency domain.

In a possible design, the processing unit 1010 is further configured to determine that the first send node and a second send node cover the communication apparatus, and that the first beacon resource and a second beacon resource of the second send node overlap in frequency domain. The interface unit 1020 is further configured to send third signaling to the first send node, where the third signaling indicates to update the first beacon resource to a third beacon resource.

In a possible design, the processing unit 1010 is further configured to update the first beacon resource of the first send node to the third beacon resource.

When the communication apparatus 1000 is configured to implement the functions of the first send node in the method embodiment shown in FIG. 2, FIG. 7, FIG. 8, or FIG. 9:

the processing unit 1010 is configured to determine one or more subcarriers that are in a first frequency band, where the first frequency band is one of N frequency bands included in a first beacon resource of the communication apparatus, and N is an integer greater than or equal to 1; and

the interface unit 1020 is configured to send a beacon signal on the one or more subcarriers.

In a possible design, the beacon signal includes at least one of the following: a preset level signal, a preset modulation symbol, a reference signal used for navigation and/or measurement and control, or measurement and control information.

In a possible design, a quantity of subcarriers sending the preset level signal or the preset modulation symbol is less than or equal to a preset threshold.

In a possible design, a CP mode is used to send the preset level signal or the preset modulation symbol.

In a possible design, the processing unit 1010 is further configured to update the first beacon resource to a third beacon resource based on coverage of the communication apparatus, coverage of a second send node, and a second beacon resource.

In a possible design, before updating the first beacon resource to the third beacon resource, the processing unit 1010 is further configured to determine that the communication apparatus and the second send node cover a first receive node, and that the first beacon resource and the second beacon resource overlap in frequency domain.

In a possible design, the interface unit 1020 is further configured to: before the processing unit 1010 updates the first beacon resource to the third beacon resource, receive second signaling from a first receive node, where the second signaling indicates that the beacon resources of the communication apparatus and the second send node overlap in frequency domain.

In a possible design, the interface unit 1020 is further configured to send first signaling to the first receive node, where the first signaling indicates to update the first beacon resource to the third beacon resource.

In a possible design, the interface unit 1020 is further configured to receive third signaling from a first receive node, where the third signaling indicates to update the first beacon resource to a third beacon resource. The processing unit 1010 is further configured to update the first beacon resource to the third beacon resource.

As shown in FIG. 11, the communication apparatus 1100 includes a processor 1110 and an interface circuit 1120. The processor 1110 and the interface circuit 1120 are coupled to each other. It may be understood that the interface circuit 1120 may be a transceiver or an input/output interface. Optionally, the communication apparatus 1100 may further include a memory 1130, configured to store instructions executed by the processor 1110, or store input data required by the processor 1110 to run instructions, or store data generated after the processor 1110 runs instructions. Optionally, the memory 1130 may alternatively be integrated with the processor 1110.

When the communication apparatus 1100 is configured to implement the method shown in FIG. 2, FIG. 7, FIG. 8, or FIG. 9, the processor 1110 is configured to implement a function of the processing unit 1010, and the interface circuit 1120 is configured to implement a function of the interface unit 1020.

When the communication apparatus is a chip used in a first receive node, the first receive node chip implements a function of the first receive node in the foregoing method embodiment. The first receive node chip receives information from another module (for example, a radio frequency module or an antenna) in the first receive node, where the information is sent by the first send node or another send node to the first receive node. Alternatively, the first receive node chip sends information to another module (for example, a radio frequency module or an antenna) in the first receive node, where the information is sent by the first receive node to the first send node or another send node.

When the communication apparatus is a chip used in the first send node, the first send node chip implements a function of the first send node in the foregoing method embodiment. The first send node chip receives information from another module (for example, a radio frequency module or an antenna) in the first send node, where the information is sent by the first receive node or another receive node or another send node to the first receive node. Alternatively, the first send node chip sends information to another module (for example, a radio frequency module or an antenna) in the first send node, where the information is sent by the first send node to the first receive node or another receive node or another send node.

It may be understood that the processor in embodiments of the present disclosure may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor, or may be any conventional processor or the like.

The method steps in embodiments of the present disclosure may be implemented by hardware, or may be implemented by the processor executing software instructions. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to the processor, so that the processor can read information from the storage medium and write information into the storage medium. Certainly, the storage medium may be a component of the processor. The processor and the storage medium may be located in an ASIC. In addition, the ASIC may be located in a network device or a terminal device. Certainly, the processor and the storage medium may exist in the network device or the terminal device as discrete components.

All or some of the foregoing embodiments may be implemented by using software, hardware, firmware, or any combination thereof. When software is used to implement embodiments, all or some of embodiments may be implemented in a form of a computer program product. The computer program product includes one or more computer programs or instructions. When the computer programs or instructions are loaded and executed on a computer, all or some of the processes or the functions in embodiments of the present disclosure are performed. The computer may be a general-purpose computer, a dedicated computer, a computer network, a network device, user equipment, or another programmable apparatus. The computer programs or instructions may be stored in a computer-readable storage medium, or may be transmitted from a computer-readable storage medium to another computer-readable storage medium. For example, the computer programs or instructions may be transmitted from a website, computer, server, or data center to another website, computer, server, or data center in a wired or wireless manner. The computer-readable storage medium may be any usable medium accessible to a computer, or a data storage device, such as a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In various embodiments of the present disclosure, unless otherwise stated or there is a logic conflict, terms and/or descriptions in different embodiments are consistent and may be mutually referenced, and technical features in different embodiments may be combined based on an internal logical relationship thereof, to form a new embodiment.

In addition, it should be understood that the word “example” in embodiments of the present disclosure is used to represent giving an example, an illustration, or a description. Any embodiment or design solution described as an “example” in should not be explained as being more preferred or having more advantages than another embodiment or design solution. The word “example” is used to present a concept in a specific manner.

In addition, in embodiments of the present disclosure, information, a signal, a message, and a channel may be interchangeably used sometimes. It should be noted that meanings expressed by the terms are consistent when differences are not emphasized. Terms “of” and “corresponding (relevant)” may be interchangeably used sometimes. It should be noted that meanings expressed by the terms are consistent when differences of the terms are not emphasized.

It may be understood that various numbers in embodiments of the present disclosure are merely used for differentiation for ease of description, and are not used to limit the scope of embodiments of the present disclosure. Sequence numbers of the foregoing processes do not mean execution sequences. The execution sequences of the processes should be determined based on functions and internal logic of the processes.

What is claimed is:

1. A beacon receiving method, comprising:
determining, by a first receive node, one or more subcarriers that are in a first frequency band, wherein the first frequency band is one of N frequency bands comprised in a first beacon resource of a first send node, and wherein Nis an integer greater than or equal to 1;
receiving, by the first receive node, a beacon signal on the one or more subcarriers; and
parsing, by the first receive node, the beacon signal.

2. The method according to claim 1, wherein the beacon signal comprises at least one of:
a preset level signal,
a preset modulation symbol,
a reference signal used for navigation and/or measurement and control, and/or
measurement and control information.

3. The method according to claim 2, wherein a quantity of subcarriers receiving the preset level signal or the preset modulation symbol is less than or equal to a preset threshold.

4. The method according to claim 2, wherein a non-cyclic prefix (CP) mode is used to receive the preset level signal or the preset modulation symbol.

5. The method according to claim 1, further comprising:
receiving, by the first receive node, first signaling from the first send node, wherein the first signaling indicates an update of the first beacon resource to a third beacon resource; and
updating, by the first receive node, the first beacon resource of the first send node to the third beacon resource.

6. The method according to claim 5, wherein before the receiving, by the first receive node, the first signaling from the first send node, the method further comprises:
determining, by the first receive node, that the first send node and a second send node cover the first receive node, and that the first beacon resource and a second beacon resource of the second send node overlap in a frequency domain; and
sending, by the first receive node, second signaling to the first send node, wherein the second signaling indicates that the beacon resources of the first send node and the second send node overlap in frequency domain.

7. The method according to claim 1, further comprising:
determining, by the first receive node, that the first send node and a second send node cover the first receive node, and that the first beacon resource and a second beacon resource of the second send node overlap in a frequency domain; and
sending, by the first receive node, third signaling to the first send node, wherein the third signaling indicates an update of the first beacon resource to a third beacon resource.

8. The method according to claim 7, further comprising:
updating, by the first receive node, the first beacon resource of the first send node to the third beacon resource.

9. A beacon sending method, comprising:
determining, by a first send node, one or more subcarriers in a first frequency band, wherein the first frequency band is one of N frequency bands comprised in a first beacon resource of the first send node, and wherein N is an integer greater than or equal to 1; and
sending, by the first send node, a beacon signal on the one or more subcarriers.

10. The method according to claim 9, wherein the beacon signal comprises at least one of:
a preset level signal,
a preset modulation symbol,
a reference signal used for navigation and/or measurement and control, and/or
measurement and control information.

11. The method according to claim 10, wherein a quantity of subcarriers sending the preset level signal or the preset modulation symbol is less than or equal to a preset threshold.

12. The method according to claim 10, wherein a non-cyclic prefix (CP) mode is used to send the preset level signal or the preset modulation symbol.

13. The method according to claim 9, further comprising:
updating, by the first send node, the first beacon resource to a third beacon resource based on coverage of the first send node, coverage of a second send node, and a second beacon resource.

14. The method according to claim 13, wherein before the updating the first beacon resource to the third beacon resource, the method further comprises:
determining, by the first send node, that the first send node and the second send node cover a first receive node, and that the first beacon resource and the second beacon resource overlap in a frequency domain.

15. The method according to claim 13, wherein before the updating the first beacon resource to the third beacon resource, the method further comprises:
receiving, by the first send node, second signaling from a first receive node, wherein the second signaling indicates that the beacon resources of the first send node and the second send node overlap in a frequency domain.

16. The method according to claim 13, further comprising:
sending, by the first send node, first signaling to a first receive node, wherein the first signaling indicates an update of the first beacon resource to the third beacon resource.

17. The method according to claim 9, further comprising:
receiving, by the first send node, third signaling from a first receive node, wherein the third signaling indicates an update of the first beacon resource to a third beacon resource; and
updating, by the first send node, the first beacon resource to the third beacon resource.

18. A communication apparatus, comprising:
at least one non-transitory memory configured to store instructions; and
at least one processor configured to:
execute the instructions to enable the communication apparatus to:
determine one or more subcarriers in a first frequency band, wherein the first frequency band is one of N frequency bands comprised in a first beacon resource of a first send node, and wherein N is an integer greater than or equal to 1;
receive a beacon signal on the one or more subcarriers; and
parse the beacon signal.

19. The apparatus according to claim 18, wherein the beacon signal comprises at least one of:
a preset level signal,
a preset modulation symbol,
a reference signal used for navigation and/or measurement and control, and/or
measurement and control information.

20. A communication apparatus, comprising:
at least one non-transitory memory configured to store instructions; and
at least one processor configured to:
execute the instructions to enable the communication apparatus to:
determine one or more subcarriers in a first frequency band, wherein the first frequency band is one of N frequency bands comprised in a first beacon resource of the communication apparatus, and wherein N is an integer greater than or equal to 1; and
send a beacon signal on the one or more subcarriers.
